(19) United States
(12) Patent Application Publication
(10) Pub. No.: US 2013/0205199 A1
(43) Pub. Date: Aug. 8, 2013

(54) Variable Template Based Document Generation

(71) Applicant: Niranjan Damera-Venkata, Fremont, CA (US)

(72) Inventor: Niranjan Damera-Venkata, Fremont, CA (US)

(21) Appl. No.: 13/825,593

(22) PCT Filed: Oct. 25, 2010
(86) PCT No.: PCT/US2010/053890

§ 371 Date: Mar. 22, 2013

(51) Int. Cl. G06F 17/21

(52) U.S. Cl. CPC G06F 17/212
USPC 715/243

(57) ABSTRACT

Document content (16) is received for rendering in accordance with one or more variable document templates (18). Scores are assigned to respective allocations of the document content (16) to a page. Based on the scores, an optimal number of pages to layout the document content (16) is determined. The following information is determined from the optimal number of pages: a respective optimal allocation of the document content (16) to each of the optimal number of pages, a respective optimal one of the variable document templates for each of the optimal number of pages, and optimal values of parameters defining the relative sizes and positions of the template elements of the ascertained optimal variable document template for each of the optimal number of pages. A document (12) is generated based on the ascertained information.

### BACKGROUND

Electronic documents are created in many different ways. For example, desktop application programs, such as Microsoft Word, Quark Design, and. Adobe InDesign, frequently are used to create electronic documents. These electronic documents contain various types of content arranged with a particular layout and style.

Template-based electronic document formats describe a predefined layout arrangement of fields that are capable of accepting variable content. In some approaches, the size, shape and placement of the template fields are fixed. In another approach, an electronic document is represented as an adaptive layout template that contains predefined content areas whose positions and sizes may be varied within specified ranges. In particular, the content areas are defined by variables with respective value domains that define the size, position, and content of the content areas. A user specifies constraints that limit variable ranges and define relationships between variables and values. A constraint solver typically generates a final document that satisfies all of the specified constraints.

Systems and methods for generating documents from variable document templates would be beneficial.

### DESCRIPTION OF DRAWINGS

FIG. 1 is a block diagram of an example of a document processing system for generating documents with variable content.

FIG. 2 is a block diagram of an example of a set of variable document templates

FIG. 3 is diagrammatic view of an example of an hierarchical arrangement of templates into collections of a template library

FIG. 4 shows an example of a process of generating be layout from document content.

FIG. 5 is a flow diagram of an example of a method of generating a document having an optimal number of pages to which document content is allocated.

FIG. 6 is a diagrammatic view of an example of a representation of a document as a sequence of templates, template parameters, and content allocations that is sampled from an overall probability distribution over P pages.

FIG. 7 is a flow diagram of an example of a method of determining an optimal number of pages for allocating document content.

FIG. 8 is a block diagram of an example of computer system.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

As used herein a “computer” is any machine, device, or apparatus that processes data according to computer-readable instructions that are stored on a computer-readable medium either temporarily or permanently. A “computer operating system” is a component of a computer system that manages and coordinates the performance of tasks and the sharing of computing and hardware resources. A “software application” (also referred to as machine readable instructions, software, an application, computer software, a computer application, a program, and a computer program) is a set of instructions that a computer can interpret and execute to perform one or more specific tasks. A “data file” a block of information that durably stores data for use by a software application.

The term “computer-readable medium” refer to any tangible, non-transitory medium capable storing information that is readable by a machine (e.g., a computer). Storage devices suitable for tangibly embodying these instructions and data include, but are not limited to, all forms of physical, non-transitory computer-readable memory, including, for example, semiconductor memory devices, such as random access memory (RAM), EPROM, EEPROM, and Flash memory devices, magnetic disks such as internal hard disks and removable hard disks, magneto-optical disks, DVD-ROM/RAM, and CD-ROM/RAM.

A “variable document template” is a data structure that specifies one or more template elements, including at least one template element that is designated for receiving variable document content. A “template element' is any component of a variable document template that is taken into account in an optimization process for determining a final document specification for document content to be inserted into the variable document template. Examples of template elements include content blocks (e.g., title text, text streams, figures, advertisements) and white space between content blocks. The adaptability of a template element to different document content typically is controlled by at least one adaptive layout parameter that is characterized by one or more respective values that typically are set by a document template designer.

As used herein, the term “page” refers to any type of discrete area in which graphic objects may be laid out, including a physical page embodied by a discrete physical medium a piece of paper) on which a layout of graphic objects may be printed, and a virtual, digital or electronic page containing a layout of graphic objects that may be presented to a user by, for example, an electronic display device.

A “window” is a visual area of a display that typically includes a user interface. A window typically displays the output of a machine readable instructions process and typically enables a user to input commands or data for the machine readable instructions process. A window that has a parent is called a “child window.” A window that has no parent, or whose parent is the desktop window, is called a “top-level window.” A “desktop” is a system-defined window that paints the background of a graphical user interface (GUI) and serves as the base for all windows displayed by all machine readable instructions processes.

As used herein, the term Includes means includes but not limited to, and the term “including' means including but not limited to. The term “based on” means based at least in part on.

The examples that are described herein provide systems and methods for generating documents from variable document templates. These examples are able to determine an optimal allocation of document content to an optical number of pages in a fast and efficient manner. Some of these examples incrementally determine an optimal allocation of document content over the best previous allocation of a subset of the document content to any page count. These examples do not require an explicit loop over page count; instead, for each document content increment an optimal page count is updated when the optimal previous subset is found. Due to their efficient use of processing and memory resources, these examples readily may be implemented in a wide variety of application environments, including embedded environments, which are subject to significant processing and memory constraints.

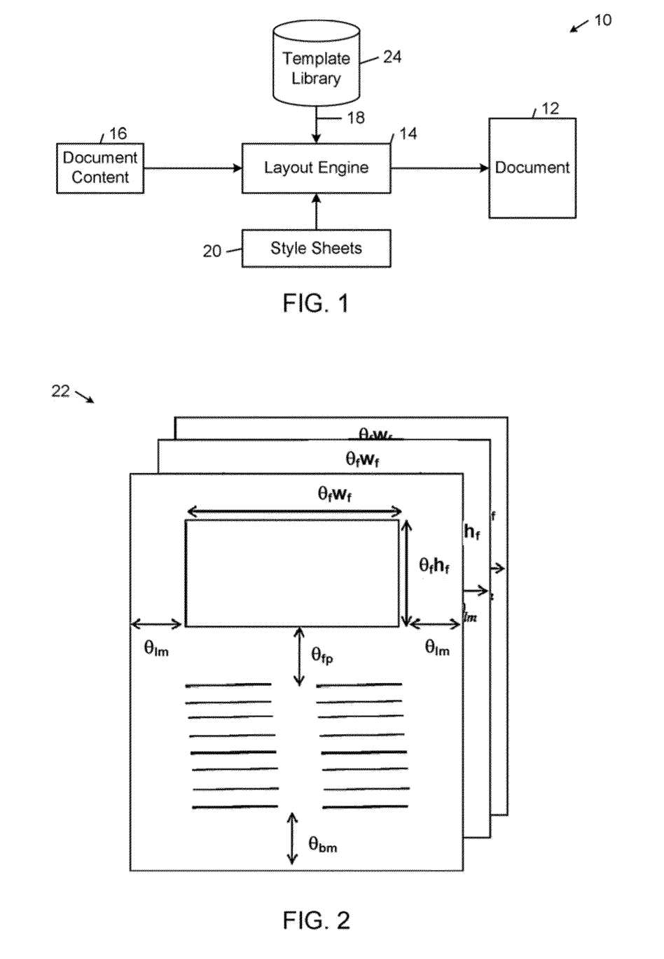

FIG. 1 shows an example of a document processing system 10 for generating a document 12 with variable content.

The document processing system 10 includes a layout engine 14 that processes electronic document content 16 based on one or more variable document templates 18 and one or more style sheets 20 to produce the document 12. In some examples, the layout engine 14 processes the document content 16 on a page-by-page basis. In other examples, the layout engine 14 may process the document content 16 on a multi-page basis. The layout engine 14 may be implemented in any computing or processing environment, including in digital electronic circuitry or in computer hardware, or machine readable instructions (including firmware or software). In some examples, the layout engine 14 is implemented by one or more respective machine readable instructions modules that are executed on a computer. Computer process instructions for implementing the layout engine 14 and the data it generates are stored in one or more computer-readable media.

The document content 16 typically includes a list of document contents e.g., figures and text), a description of the logical relationships (e g., linkages) between the document contents, and annotations that assigning respective types to the contents (e.g., title, header, sidebar, pull quote, and advertisement) in accordance with a content description schema that is parsable by the layout engine 14. In an example for a typical magazine, the document content 16 may include a stream of text blocks, a stream of figures, a stream of sidebars, a stream of pull quotes, a stream of advertisements, and a description of the logical relationships between these contents. In some examples, the document content 16 is contained in an XML (eXtensible Markup Language) data file that describes the structure of the document contents and identifies the types of the document content elements with attribute tags in accordance with a markup language schema. This representation decouples the content from the presentation and allows variation in the size, number and relationship among content blocks. Adding or deleting content elements is accomplished easily by addition or deletion of sub-trees in the XML structure, and content modifications simply involve changing the content of an XML leaf-node.

The following is an example of XML document content specification:

<root template library=“ABC.xml” library collection=“report”>

<title id=“0”>TITLE TEXT BLOCK</title>
<sidebar ref=“0” name“profile”>

<f w=“1661” ref=“0” h=“2164” src=“XYZjpg” id=“1”> </f>
<t type=“sidebar_para” id=“1”>SIDEBAR TEXT BLOCK,
</t>
<t type=“sbpara” id=“2”>

SIDEBAR TEXT BLOCK

</t>

<t type=“sbpara” id=“3”>
SIDEBAR TEXT BLOCK

</t> = {ending tag}

</sb>

<t type=“head” id=“1”>HEADER TEXT BLOCK </t>
<t type=“para” id=“2”>
PARAGRAPH TEXT BLOCK

</t>
<t type=“spacer” id=“3”> </t>

<t type=“para” id=“4”>PARAGRAPH TEXT BLOCK</t>
<t type=“list” id=“5”>
LIST ITEM 1 TEXT BLOCK

```
  </t>
  <t type=“list” id=“6”>
```

LIST ITEM 2 TEXT BLOCK

</t>

<t type=“spacer” id=“8”> </t>

<t type=“para” id=“9”>
PARAGRAPH TEXT

</t>
</root>

In this example, the XML document content specification identifies a template library (i.e., ABC.xml) and a template collection (i.e., report) within the template library from which the layout engine 14 selects one or more templates that are adapted to accommodate the documents contents contained in the XML document content specification. The XML document content specification also describes a title a sidebar that includes a figure (i.e., XYZ.jpg) and a number of text blocks, a header, several paragraphs, a number of list items, and a number of spacers.

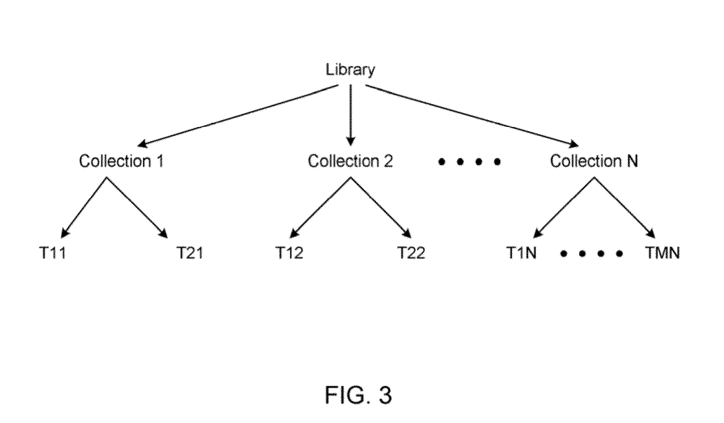

FIG. 2 shows an example of a set 22 of the variable document templates 18, where the θ's represent template element parameters (e.g., white space dimensions and figure scale factors) that influence the adaptability of the template elements to different document content. The variable document templates 18 are selected from a template library 24 that contains an indexed set of variable document templates. FIG. 3 shows an example of an hierarchical arrangement of templates (T11, . . . , TMN) into collections (Collection 1, . . . , Collection N) of a template library. In some examples each template library represents a particular type of document (e.g., annual report or newsletter), and each collection represents a section (e.g., appendix or table of contents) of a document of the type represented by the library. In some example, a specification of all the templates and collections of a particular template library is stored in one or more XML data files.

Different styles can be applied to the same variable document template 18 via the style sheets 20. A variable document template 18 typically specifies one or more associated style sheets 20 for formatting respective sections of the template. As explained above, the content blocks within the document content 16 typically have attributes that denote their type (e.g., text blocks may be tagged as header, sub-header, list item, paragraph, and caption). The document style sheet 20 associated with the selected variable document template defines the type definitions and the formatting for the types of the content blocks in the document content 16. For example, the style sheet may define a “header” to use Arial bold font with a specified font size and line spacing. Different style sheets can apply different formatting to the same document content 16. Also, type definitions are scoped within template elements. For example, two different types of sidebars may have different text formatting applied to side bar text with a sub-header attribute. The style sheet 20 also typically defines overall document characteristics, such as, margins, bleeds, page dimensions, and spreads. Different sections of the same document may be formatted with different style sheets Style sheets typically are created by a professional graphic designer.

The document 12 may be any type of electronic document, including an editable markup document (e.g., an. Adobe FrameMaker document, a rich text format document, or a Microsoft Word document), a formatted markup document (e.g., an Adobe PDF document or an Adobe PostScript document), and a rendered image document (e.g., a bit map image document). The document 12 may contain one or more pages of content.

In operation, the layout engine 14 processes the document content 16 to determine an appropriate variable document template 18 to select from the template library 24 for each page of the document 12. The layout engine 14 also selects one or more style sheets 20 for formatting the document content 16. Based on the document content 16, the selected variable document templates 18, and the selected style sheets 20 determines the values of the variables in the selected variable document templates 18 based on an optimization process. The layout engine 14 generates the document 12 based on the variable document templates 18, the determined variable values, and the document content 16. In this process, the layout engine 14 populates the variables in the variable document templates 18 with the determined variable values. At this point, the resulting one or more layout templates 18 fully specify the layout of the document 12. The layout engine 14 generates the document 12 by rendering the document content 16 in accordance with the resulting, fully-specified layout template. Multiple customized documents 12 may be generated based on the selected variable document templates 18 simply by changing the document content 16.

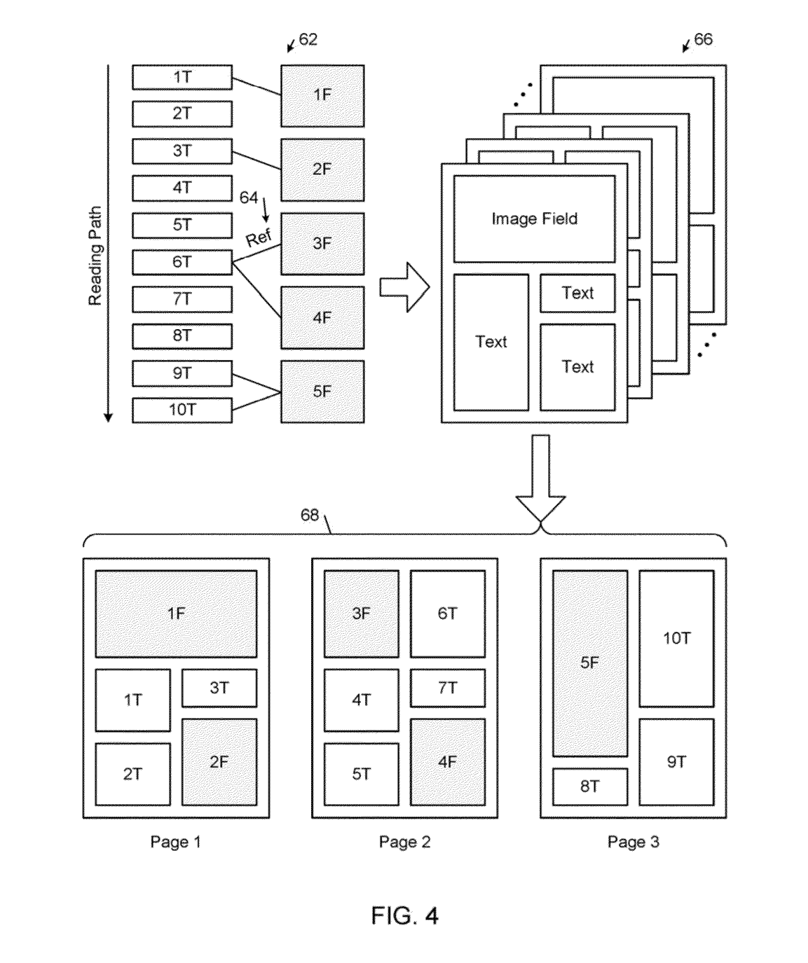

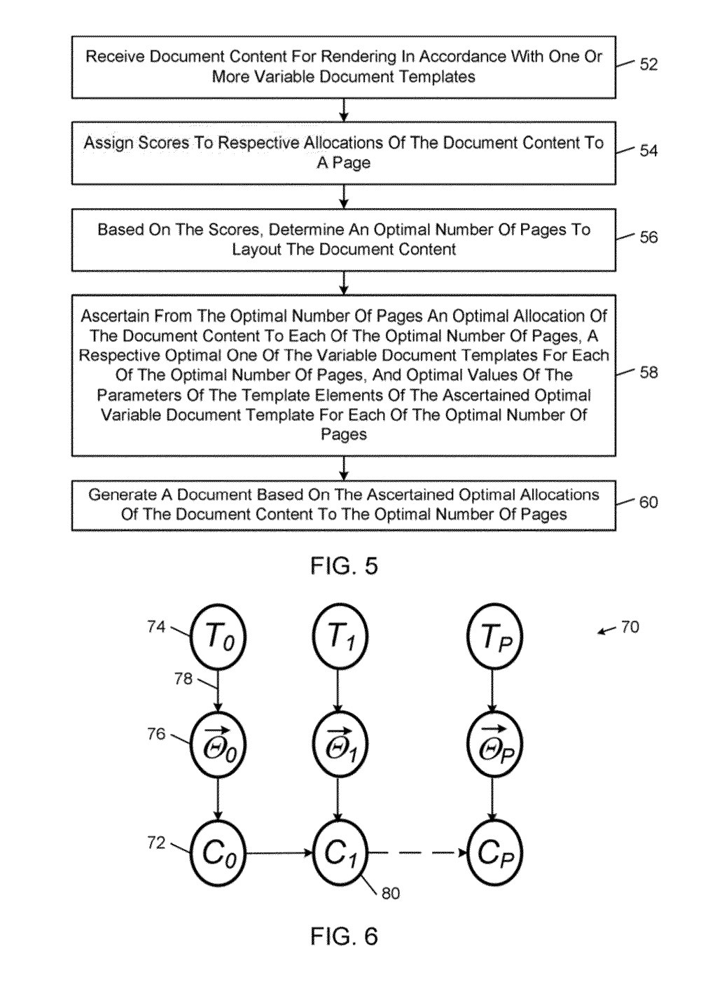

FIG. 4 shows an example of a process of generating an optimized document layout from raw input content. Raw input content 62 comprises text, figures, references, and semantic information. The text portion of the raw input 62 is represented by rectangular blocks labeled 1T-10T, each block representing text such as one or more paragraphs or a heading, and the figures portion of the raw input content 62 is represented by squares labeled 1F-5F, each square representing a figure. The raw input content 62 also includes semantic information represented by lines extending between text blocks and figures. Semantic information can include which text blocks correspond to headings and which text blocks reference figures. For example, text block 1T makes reference to FIG. 1F and text blocks 9T and 10T make reference to figure 5F. Semantic information also identifies which text blocks and figures are associated with a reference. For example, reference 64 corresponds to text block 6T and FIG. 3F. Note the raw input content does not include which text, figures, and references are to be selected for each page or how text, figures, and references are to be arranged on each page of the overall document,

An allocation of text, figures, and references is determined for each page of the document. Each allocation corresponds to the number of lines of text n_{L} and the number of figures n_{F} assigned to a respective page of the output document. Allocation of content to the first j pages is represented by a random variable Aⱼ, where j is a non-negative integer used to identify a page of the document. In the examples illustrated herein, j equals “0” for the first page of the document. A random variable is a function whose domain is a sample space and whose range is a set of real numbers. For example, referring to FIG. 4, an example of a sample space corresponding to the first page of the document can be the set:

S₀={[1T;1F],[1T,2T;1F],[1T,2T,3T;1F,2F],[1T,2T,3T,4T;1F,2F]} (1)

where each element in S₀ is a bracket listing text blocks and figures that can be allocated to the first page of the document. The random variable A₀ assigns a real value to each element in S₀. Allocations for pages 2 through P+1 are denoted by A₁ through A_{P}, respectively, and are similarly defined with an allocation for a subsequent page dependent upon the allocation for the previous page. As described in detail below, optimal content allocations A*ⱼ are determined for each set of pages [0:j]. For example, a possible optimal allocation A*ᵢⱼ for the first page (P=0) may be the sample space element [1T,2T,3T;1F,2F].

Once the optimal allocations are determined for the document, an optimal template is determined for each optimal allocation. Suppose the optimal allocation A*₀ for the first pace is [1T,2T,3T;1F,2F]. There may be a number of templates in the template library 66 that can accommodate the text and figures associated with the optical allocation A*₀. These templates form a sample space of a template random variable T₀ associated with the first page. Template random variables T₁, . . . , T_{P} associated with allocations for pages 2 through P+1 are similarly defined, with the sample space of each template random variable Tⱼ corresponding to a subset of templates in the template library 66. As described in detail below, the optimal template is determined for each of the optimal allocations.

Once an optimal template is determined for each page of the document, an optimal set of template parameters \vec{Θ}ⱼ associated with dimensioning and spacing template elements is determined as described below, and each page of the document is rendered. For example, FIG. 4 shows an example of a final document layout 68 for the raw input content 62 that might be generated by the systems and methods described herein. The document layout includes three pages, where the first page has the optimal allocation [1T,2T,3T;1F,2F] and an optimal template selected from the template library 68 with optimal figure and white space parameters \vec{Θ}₀, the other two pages also have respective optimal allocations, templates, and parameters.

Note that with the exception of the first page, allocations for subsequent pages depend on the allocation for the previous page. For example, consider once again the example allocation of text blocks and figures for the first page, [1T,2T,3T;1F,2F]. The allocation for the second page cannot also include text blocks 1T, 2T, 3T and FIGS. 1F and 2F, because these text blocks and figures have already been assigned to the first page.

FIG. 5 shows an example of a method by which the layout engine 14 generates a document having an optimal number of pages to which document content is allocated. In this process, the layout engine 14 allocates the document content 16 to an optimal number of pages that constitute the document 12. In accordance with this method, the layout engine 14 receives the document content 16 for rendering in accordance with one or more of the variable document templates 18 (FIG. 5, block 52). Each variable document template includes one or more respective template elements associated with respective parameters defining relative sizes and positions of the template elements on a page. The layout engine 14 assigns scores to respective allocations of the document content to a page (FIG. 5, block 54). Based on the scores, the layout engine 14 determines an optimal number of pages to layout the document content (FIG. 5, block 56). The layout engine 14 ascertains from the optimal number of pages a respective optimal allocation of the document content to each of the optimal number of pages, a respective optimal one of the variable document templates for each of the optimal number of pages, and optimal values of the parameters of the template elements of the ascertained optimal variable document template for each of the optimal number of pages (FIG. 5, block 58). The layout engine 14 generates a document based on the ascertained optimal allocations of the document content to the optimal number of pages (FIG. 5, block 60).

In some examples, for each of the optimal number of pages, the layout engine 14 determines a respective one of the one or more variable document templates for rendering the respective optimal allocation of the document content ascertained for the page. As explained above, each of the variable document templates typically includes values of parameters specifying respective relative positions and sizes for document content and influencing the adaptability of the template element to different document contents, where the distribution of parameter values characterizes a degree of variability of the associated adaptive layout variable. In these examples, for each of the optimal number of pages, the layout engine 14 determines optimal values of the parameters of the respective variable document template respectively determined for the page.

In some examples, the layout engine 14 is implemented by a probabilistic layout engine that produces variable content documents based on a probabilistic model that assigns a probability score to every possible document, with higher quality documents receiving higher scores. The model parameters typically are set by a user (typically a professional graphic designer) using the template design module 26 described above. In these examples, the layout engine 14 learns (or fits) the model and then finds a global optimal document that maximizes a probability score given content (e.g., text, figures, and logical relationships between them) by determining a probabilistic inference over a Elayesian network. Examples of the probabilistic layout engine are described in detail below. Additional details regarding the structure and operation of examples of the probabilistic layout engine are described in co-pending International Patent Application No. PCT/US09/61320, filed Oct. 20, 2009, and in co-pending International Patent Application No. PCT/US09/62288, filed Oct. 28, 2009.

The probabilistic layout engine typically includes three components: a parser that parses style sheets, variable document templates, and input document content into internal data structures: an inference engine that computes optimal layouts, given the document content; and a rendering engine that renders the final output document.

In some examples, the parser module includes three separate parsers: a style sheet parser: a content parser; and a variable document template parser. The style sheet parser reads the style sheet 20 for each document content stream 16 and creates a style structure that includes document style and font styles. The content parser reads the content stream and creates respective arrays of structures for figures, text, and sidebars.

The text structure array (referred to as the chunk array) includes information about each independent chunk of text that are placed on the page. A single text block in the content stream may be chunked as a whole if it cannot flow across columns or pages (e.g., headings, text within sidebars, etc.). If the text block is allowed to flow (e.g., paragraphs, lists, etc.), it is decomposed into smaller chunks that are rendered atomically. Each structure in the chunk array includes its index in the array, chunk height, whether a column or page break is allowed at the chunk, the identifier of the content block to which the chunk belongs, the block type, and an index into the style array to access the style to render the chunk. The height of a chunk is determined by rendering the text chunk at all possible text widths using the specified style in an off screen rendering process. In some examples, the probabilistic layout engine uses the Scribus desktop publishing rendering engine, which allows the probabilistic layout engine to query the number of rendered lines via an API (Application Programming Interface) of the Scribus application. The probabilistic layout engine uses the number of lines and information regarding the font style and line spacing to calculate the rendered height of a chunk.

Each figure structure in the figure structure array encapsulates the figure properties of an actual figure in the content stream, such as width, height, source filename, caption and the text block id of a text block which references the figure. Figure captions are handled similar to a single text chunk described above allowing various caption widths based on where the caption actually occurs in a template (e.g., full width captions span text columns, while column width captions span a single text column).

Each content sidebar structure in the sidebar structure array may appear in any sidebar template slot (unless explicitly restricted), so the sidebar array has elements which are themselves arrays with individual elements describing allocations to different possible sidebar styles. Each of these structures has a separate figure array and chunk array for figures and text that appear within a particular template sidebar.

Given the document content 16, style sheets 20, and the variable document templates 18, the inference engine solves for the optimal layout of the given content by simultaneously allocating content to a sequence of templates chosen from the template library, and solving for template parameters that allow maximal page fill while incorporating the aesthetic judgements of the graphic designers encoded in the prior parameter distributions. The inference engine is based on a framework referred to herein as the Probabilistic Document Model (PDM), which models the generation of arbitrary multi-page documents.

By way of overview, according to the PDM the i^{th} page of a document is generated by first choosing a template Tᵢ from a library of templates, then setting its parameter vector Θᵢ, and then allocating content Cᵢ (e.g., images sidebars, and text blocks) to that page. Each of these tasks is performed by sampling from a conditional probability distribution. For example, P(Tᵢ=tₖ) is the probability of picking a particular template tₖ for the i^{th} page from a set of K templates in the template library. If there is no a priori choice for a template, this probability is typically simply 1/K. Other values can be set for the template probabilities so that certain templates can be made more of less likely to be used in creating a document. Thus

$$P ( {T}_{i} ) = {p}_{k} where {\sum }_{k}^{K} {p}_{k} = 1 \qquad ( 2 )$$

Once a template is selected, the inference engine samples its parameter vector Θᵢ from the conditional distribution P(Θᵢ|Tᵢ). The inference engine models this distribution to be a multivariate normal distribution that describes the prior probabilities of various parameter settings. This distribution can be directly derived from the parameter distributions in the variable document templates that encode the template designers aesthetic choices about desired parameter values. Sampling from this distribution makes these aesthetic parameter settings more likely. Thus:

P(Θᵢ|Tⱼ)=N(Θᵢ| Θ̅ᵢ, A⁻¹) (3)

Where Θ̅ⱼ and A represent the means and precisions of the parameters as entered by a graphic designer. In fact any desired linear relation (proportions, ratios etc.) between parameters can be captured in the above prior probability distribution.

Finally, the inference engine samples the allocation for the current page Cᵢ from a probability distribution P(Cᵢ|Cᵢ₋₁, Θᵢ). In this example, the model assumes that the current allocation is independent of the template and parameter selections for all previous pages, given the allocation to the previous page and the parameter settings for the current page. The allocation to the previous page affects the probability of an allocation for the current page via the logical relationship content in the previous page has to content on the current page. First, information on content allocated to the previous page is sufficient to conclude that all prior content has already been allocated. Thus, previous page allocation allows the inference engine to determine if a figure or sidebar appearing on the current page is referenced in a prior page. This would reduce the probability of the current allocation since the figure/sidebar does not appear on the same page as its reference. Furthermore, P(Aᵢ|Aᵢ₋₁, Θᵢ) depends on the parameter settings since certain parameter settings fill the page with the existing content better than others and are hence assigned higher probability. This conditional distribution is given by:

$$P ( {C}_{i} \vert {C}_{i - 1} , {Θ}_{i} ) ∝ exp ( - γ \vert R ( {C}_{i} , {C}_{i - 1} ) \vert ) {\prod }_{m = 1}^{M} N ( {H}_{m} ( {C}_{i} ) \vert {Θ}_{i}^{T} {y}_{m} , {α}^{- 1} ) {\prod }_{n = 1}^{N} N ( {W}_{n} ( {C}_{i} ) \vert {Θ}_{i}^{T} {x}_{n} , {β}^{- 1} ) \qquad ( 4 )$$

In the above equation, |R(Aᵢ, Aᵢ₋₁)| represents the number of dangling references due to the allocation Aᵢ to the page and i^{th} to the (i-1)^{th} page. The constant γ represents an exponential weighting factor that represents how much to penalize mismatched references in the probability distribution. Hₘ(Aᵢ) and Wₙ(Aᵢ) represent the height and width of a Y and X path group respectively after subtracting fixed spaces and reserved regions in the Y and X directions. The variables yₘ and xₙ represent content dependent vectors that represent actual figure heights, widths and whitespace in each direction, for each path group. For good page fill in the Y and X directions Hₘ(Aᵢ)−Θⱼ^{T}yₘ≈0 and Wₙ(Qᵢ)−Θᵢ^{T}xₙ≈0. The normal distributions above simply assign high probability to these events and lower probability for deviations from ideal. The constants α and β are precision variables of the normal distribution that control the degree to which production of full pages is favored.

The following is a detailed description of examples of processes for generating a document from one or more variable document templates in accordance with the Probabilistic Document Model described above.

In these examples, the probabilistic layout engine generates documents by repeating the sampling process, page by page. Thus, a document is a sequence of templates, template parameters, and content allocations that is sampled from an overall probability distribution over P pages, given by:

$$P ( \{ {T}_{i} \} , \{ {Θ}_{i} \} , \{ {C}_{i} \} ) = P ( {A}_{0} \vert {Θ}_{0} ) P ( {Θ}_{0} \vert {T}_{0} ) P ( {T}_{0} ) {\prod }_{i = 1}^{P} P ( {A}_{i} \vert {A}_{i - 1} , {Θ}_{i} ) P ( {Θ}_{i} \vert {T}_{i} ) P ( {T}_{i} ) \qquad ( 5 )$$

This distribution may be represented by directed graph shown in FIG. 6. The distribution is generated from the graph by multiplying the conditional probability distributions of each node conditioned only on its parents. Such a model is called a Bayesian network 70 for the underlying probability distribution characterizing conditional independencies of the random variables associated with allocations Aⱼ, templates Tⱼ, and parameters Θ̅ⱼ. Each node of the Bayesian network 70 represents a random variable corresponding to events in a sample space. For example, node 72 represents a random variable A₀ associated with a sample space of allocations for the first page, node 74 represents a random variable T₀ associated with a sample space of templates for the allocation selected for the first page, and node 76 represents the random variable vector \vec{Θ}₀ associated with a sample space of parameters for the template selected for the first page. Directional arrows in the Bayesian network independently identify conditional probabilities between nodes. For example, directional arrow 78 represents the conditional probability P(\vec{Θ}₀|T₉) for a set of parameters \vec{Θ}₀ given a template T₀, but the allocations A₁, . . . , A_{P} have more than one parent node. Thus, the conditional probability for the node 80 representing the allocation A₁ is P(Aᵢ|A₀, Θᵢ). Note that the Bayesian network defines an conditional independency structure. In other words, any node is conditionally independent of its non-descendent given its parent. For nodes like T₀, . . . , T_{P} the probabilities associated with these nodes P(T₀), . . . , P(T_{P}) are not conditioned on any other nodes.

The Probabilistic Document Model is generative, in the sense that a sequential process (as described above) can be used to generate pages and thus documents from the model. The documents generated by this process are samples drawn by the inference engine from the probability distribution described above. Although the sampling procedure generates documents with various probabilities (recall that higher probabilities translate to higher quality), the inference engine is configured to find the document that has the highest probability. In this process, the inference engine computes the optimizing sequence of templates {T*ᵢ}, template parameters {Θ*ᵢ}, and allocations {A*ᵢ} that maximize document probability.

A joint probability distribution that characterizes the conditional probabilities of a Bayesian network is a product of the probabilities of the parent nodes and the conditional probabilities. Thus, the joint probability distribution associated with the Bayesian network 70 is given by:

$$P ( \{ {T}_{j} \} , \{ {\overline{Θ}}_{j} \} , \{ {A}_{j} \} ) = P ( {A}_{0} \vert {\overline{Θ}}_{0} ) P ( {\overline{Θ}}_{0} \vert {T}_{0} ) P ( {T}_{0} ) \times {\prod }_{j = 1}^{P} P ( {A}_{j} \vert {A}_{j - 1} , {\overline{Θ}}_{j} ) P ( {\overline{Θ}}_{j} \vert {T}_{j} ) P ( {T}_{j} ) \qquad ( 6 )$$

As shown in FIG. 6, allocation A₀ for the first page “0” is independent, but allocations for each of the subsequent pages depend on the allocation for the previous page. Thus, P({Tⱼ},{ Θ̅ⱼ},{Aⱼ}) includes the terms P(Aⱼ|Aⱼ₋₁, Θ̅ⱼ).

In the examples described herein, the optimization process performed by the inference engine is predicated on maximizing P({Tⱼ},{ Θ̅ⱼ},{Aⱼ}) with the assumption that the larger the probability P({Tⱼ},{ Θ̅ⱼ},{Aⱼ}), the closer the docuoment layout is to having the following desired document properties:
(1) each page of the document should look as good as possible to achieve overall optimal layout quality;
(2) text blocks that reference figures and the corresponding figures should appear on the same page; and
(3) the total number of pages is minimized.

In order to determine the sets {Tⱼ}, { Θ̅ⱼ}, and {Aⱼ} for a document that give the maximum probability P({Tⱼ},{ Θ̅ⱼ},{Aⱼ}), a maximum joint probability distribution is defined as follows:

$$\begin{matrix}{P}^{*} ( \{ {T}_{j} \} , \{ {\overline{Θ}}_{j} \} , \{ {A}_{j} \} ) = {max}_{\{ {A}_{j} \}} φ ( {A}_{0} ) {\prod }_{j = 1}^{P} φ ( {A}_{j} , {A}_{j - 1} ) & ( 7 ) \\ φ ( {A}_{j} , {A}_{j - 1} ) = {max}_{{T}_{j}} ψ ( {A}_{j} , {A}_{j - 1} , {T}_{j} ) P ( {T}_{j} ) & ( 8 ) \\ ψ ( {A}_{j} , {A}_{j - 1} , {T}_{j} ) = {max}_{{\overline{Θ}}_{j}} P ( {A}_{j} \vert {A}_{j - 1} , {\overline{Θ}}_{j} ) P ( {\overline{Θ}}_{j} \vert {T}_{j} ) & ( 9 )\end{matrix}$$

Equations (7), (8), and (9) are used to determined optimal allocations, templates, and template parameters. As explained in detail below, the set of allocations {Aⱼ} that maximize equation (7) can be obtained by first determining the φ's. Each φ is a function of random variables, and is the maximum of a sequence of real numbers, one for each template Tⱼ, as described in equation (8). Hence for each Aⱼ and Aⱼ₋₁ we have a maximizing template t*ⱼ. Thus, the φ's assign a respective maximal score for each layout of the respective allocation on the page in accordance with a respective one of variable document templates. For the first page, φ(A₀) is the maximum of the range of real values associated with the allocation A₀. For subsequent pages, φ(Aⱼ, Aⱼ₋₁) is the maximum of the range of real values associated with the allocations Aⱼ and Aⱼ₋₁.

As explained above, although all the variables influence each other in general a variable is directly influenced by a few neighbors at most. This fact allows the inference engine to use the structure of the graph in performing the desired maximization. The variable Θ₀ appears in only two terms with two other variables, A₀ and T₀. This allows the inference engine to maximize over Θ₀ without looping over every possible value of every node (variable) in the network. Thus we have:

$$Ψ ( {A}_{0} , {T}_{0} ) = {max}_{{Θ}_{0}} P ( {A}_{0} \vert {Θ}_{0} ) P ( {Θ}_{0} \vert {T}_{0} ) = {max}_{{Θ}_{0}} P ( {Θ}_{0} \vert {A}_{0} , {T}_{0} ) \qquad ( 10 )$$

This maximization is performed for all possible values of A₀ and T₀ but the inference engine does not need to consider variations in other variables in the network. Even so, this is would still be a challenging task in general. The particular distributions that are used for P(Θⱼ|Tᵢ) and P(Aᵢ|Aᵢ₋₁, Θᵢ) make this task particularly efficient for the inference engine since these are conjugate normal distributions and their product also is normal. The maximizing value is the mean of the distribution, which can be computed in closed form using the equation

$${Θ}_{i}^{*} = {( Λ + {\sum }_{m} α {x}_{m} {x}_{m}^{T} + {\sum }_{n} β {y}_{n} {y}_{n}^{T} )}^{- 1} \{ Λ \overline{Θ} + {\sum }_{m} α {W}_{m} ( {A}_{i} ) {x}_{m} + {\sum }_{n} β {H}_{n} ( {A}_{i} ) {y}_{n} \} \qquad ( 11 )$$

This efficient to compute, and the effect of incremental allocations is even more efficient to compute. Allocating an additional text chunk would affect the right hand side of the above equation and a few multiply accumulates are used to update from ψ(A₀,T₀) to ψ(A₀+δ,T₀). In some examples additional speedup in computing ψ(A₀,T₀) is obtained by configuring the inference engine to screen allocation A₀ and avoiding computation altogether for invalid allocations (e.g., figure or sidebar occurring before its reference, widowed or orphaned text chunks etc.), screen templates for compatibility (e.g., content with two figures cannot be allocated to a template with only one figure); and screen for too much and too little content that make it impossible to fill he page even when template parameters are maximum or minimum. These screening approaches significantly reduce the number of cases for which optimization is performed.

Once ψ(A₀,T₀) is computed, the inference engine maximizes over template choices of the variable T₀, which occurs only in the terms P(T₀) and ψ(A₀,T₀), to compute:

$$φ ( {A}_{0} ) = {max}_{{T}_{0}} Ψ ( {A}_{0} , {T}_{0} ) P ( {T}_{0} ) \qquad ( 12 )$$

In general, eliminating (via maximization) variables Θᵢ a and Tᵢ yields the functions φ(Aᵢ,Aᵢ₋₁). The functions φ(Aᵢ,Aᵢ₋₁) assign scores to respective allocations Aᵢ-Aᵢ₋₁ of the document content to a page, where Aᵢ-Aᵢ₋₁ represents the difference between the document content respectively allocated to page i and the document content respectively allocated to page i-1. The respective portions of the document content represented by Aᵢ-Aᵢ₋₁ are used to determine the best scoring allocation of content Aᵢ-Aᵢ₋₁ to page i. Note that for i=0, φ(A₀) is simply φ(A₀, {}).

The inference engine proceeds by determining the optimal allocation of the total content over an optimal number of pages (i.e., the number of pages that maximizes the overall score for the document).

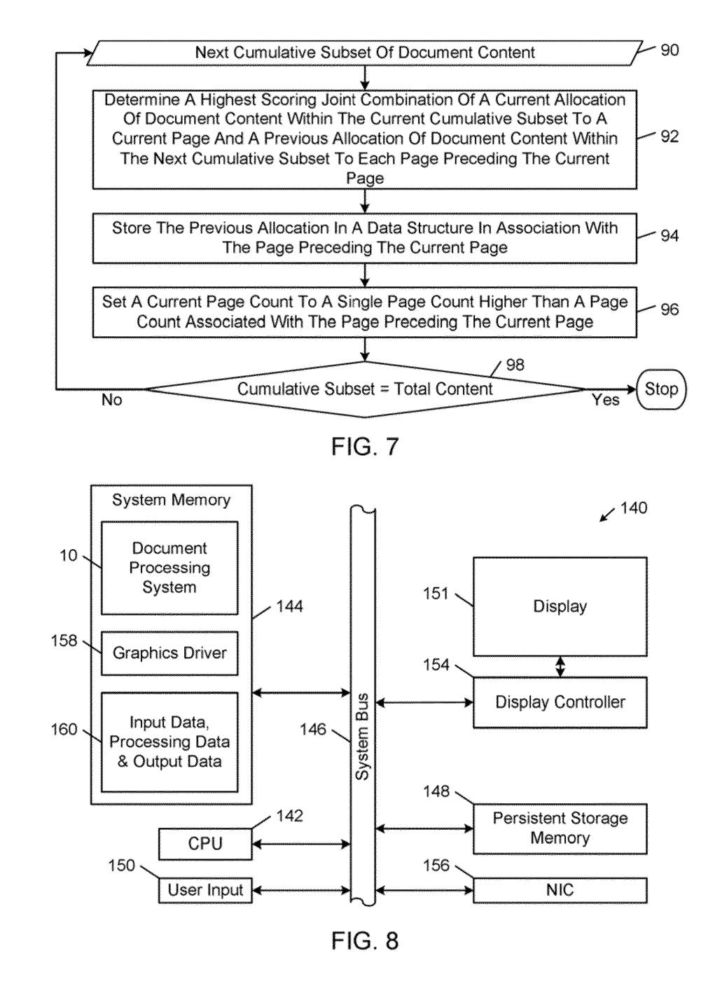

FIG. 7 shows an example of a method by which the inference engine determines the optimal number of pages and generates a data structure (e.g., a table) that stores a sequence of optimal allocations of the document content to respective sets of the pages.

In accordance with the method of FIG. 7, the inference engine selects the next cumulative subset of document content A (FIG. 7, block 90). In some examples, the next cumulative subset of document content is represented by |A|, which ranges from |A|=1 to |A|=|C|, where C represents the total document content to be allocated.

The inference engine determines a highest scoring joint combination of a current allocation of content within the current cumulative subset to a current page and a previous allocation of content within the next cumulative subset to each page preceding the current page (FIG. 7, block 92). In some examples, the score of the joint combination is given by P*=φ(A,B)P*(B), where 0⊂B⊂A and P*(B) is the maximum score associated with the prior allocation B; the highest scoring joint combination corresponds to the allocation of A-B to the current page and the allocation of the remaining content B to each of the pages preceding the current page that maximize the joint combination score. In some examples, in the process of determining the optimal number of pages, the inference engine performs the following operations for each of multiple cumulative subsets of the document content: the layout engine 14 determines a highest scoring combination of a current allocation of content within the cumulative subset to a current page and a prior allocation of content within the cumulative subset to each page preceding the current page; and the inference engine sets a current page count equal to a page count associated with the current page. In these examples, the optimal number of pages corresponds to the current page count set for the cumulative subset equal to all the document content.

The inference engine stores the previous avocation in a data structure in association with the page preceding the current page (FIG. 7, block 94). In some examples, the inference engine stores the prior allocation B that that maximizes the joint combination score P*=φ(A,B)P*(B). In some examples, for each of multiple cumulative subsets of the document content, the inference engine stores the prior allocation of the document content in a data structure in association with an index value corresponding to the page preceding the current page.

The inference engine sets a current page count to a single page count higher than a page count associated with the page preceding the current page (FIG. 7, block 96). That is, the count of the pages preceding the current page is incremented by one to produce the current page count.

The process is repeated for each cumulative subset of document content until current cumulative subset is equal to the total document content to be allocated (FIG. 7, block 98).

Once the optimal number of pages has been determined, the inference engine ascertains the optimal allocation of the document content to each of the optimal number of pages. In some examples, this process involves allocating all the document content to a last one of the pages highest in page number and, for each pair of consecutive pages from a last one of the pages to a first one of the pages, assigning to the page of the pair higher in page number a respective portion of the document content corresponding to a difference between the document content respectively allocated to the page of the pair higher in page number and the document content respectively allocated to the page of the pair consecutively lower in page number. In examples in which the prior allocation of the document content are stored in a data structure in association with an index value corresponding to the page preceding the current page, the process of assigning the respective portion of the document content to each page may involve sequentially retrieving the prior allocations stored in the data structure in order from the highest index value to the lowest index value, and determining respective differences between consecutive ones of the retrieved prior allocations.

Once the allocations for each page are determined, the inference engine looks up the optimal template for each page by finding the template Tᵢ* that maximizes ψ(Cᵢ*,Tᵢ). Once the template and the allocation are known, the inference engine determines the template parameters using the closed form solution for Θᵢ* given above. Once the page count, allocations to pages, template selection, and parameter estimation are done the inference task is complete. The solution found by this approach is globally optimal, at a significant computational advantage over exhaustive enumeration of all possibilities.

After the set of optimal allocations have been deter lined, for each optimal allocation, equations (8) and (9) can be used to determine an optimal Tⱼ and Θ̅ⱼ. For each Aⱼ there is a set of Tjs. Once a φ(Aⱼ, Aⱼ₋₁) is determined, the corresponding Tⱼ maximizes equation (8) and the corresponding template parameters Θ̅ⱼ maximize equation (3). In equation (9), P(Aⱼ|Aⱼ₋₁, Θ̅ⱼ ) is the product of layout quality, reference quality, and page qualities probabilities given by:

P(Aⱼ|Aⱼ₋₁, Θ̅ⱼ)=P_{Q}(Aⱼ|Aⱼ₋₁, Θ̅ⱼ)P_{R}(Aⱼ|Aⱼ₋₁)P_{P}(Aⱼ|Aⱼ₋₁) (13)

The conditional probability P_{Q}(Aⱼ|Aⱼ₋₁, Θ̅ⱼ) associated with layout quality is determined by a document designer. The reference quality probability can be defined as follows:

P_{R}(Aⱼ|Aⱼ₋₁)∝exp{−γ|R_{A}_{_{j,}}_{A}_{ⱼ₋₁}|} (14)

where γ is a reference constant assigned by the document designer, and |R_{A}_{ⱼ}_{,A}_{ⱼ₋₁}| corresponds to the number of misplaced references due to the previous allocation Aⱼ₋₁. The page quantity probability can be defined as follows:

P_{P}(Aⱼ|Aⱼ₋₁)∝ exp{−δ} (15)

where δ is a page constant assigned by the document designer and corresponds to a page number penalty that is used to control the overall number of pages in the final document

Next, a closed form equation for determining the parameter vector Θ̅ⱼ for each template is now described. This dosed form description can be obtained by considering the relationship between dimensions of elements of a template with m rows of image fields and n columns of image fields and the corresponding parameter vector Θ̅ in terms of Bayes' Theorem from probability theory as follows:

P(\vec{Θ}|\vec{W},\vec{H},\vec{x},\vec{y})∝P(\vec{W},\vec{H},\vec{x},\vec{y}|\vec{Θ})P(\vec{Θ}) (16)

where \vec{W}[W₁, W₂, . . . , Wₘ]^{T}, \vec{H}=[H₁, H₂, . . . , Hₙ]^{T}, \vec{x}=[\vec{x}₁, \vec{x}₂, . . . , \vec{x}ₘ]^{T}, \vec{y}=[\vec{y}₁, \vec{y}₂, . . . , \vec{y}ₙ]^{T}, and the exponent T represents the transpose from matrix theory. Vector notation is used to succinctly represent template constants Wᵢ and corresponding vectors \vec{x}ᵢ associated with the m rows and template constants Hⱼ and corresponding vectors \vec{y}ⱼ associated with the n columns of the template.

Equation (16) is in the form of Bayes' Theorem but with the normalizing probability P(\vec{W},\vec{H}, \vec{x},\vec{y}) excluded from the denominator of the right-hand side of equation (1) (e.g., see the definition of Bayes' Theorem provided in the subsection titled An Overview of Bayes' Theorem and Notation from Probability Theory). As demonstrated below, the normalizing probability P(\vec{W},\vec{H},\vec{x},\vec{y}) does not contribute to determining the template parameters \vec{Θ} that maximize the posterior probability P(\vec{Θ}|\vec{W},\vec{H},\vec{x},\vec{y}), and for this reason P(\vec{W},\vec{H},\vec{x},\vec{y}) can be excluded from the denominator of the right-hand side of equation (7).

In equation (16), the term P(\vec{Θ}) is the prior probability associated with the parameter vector \vec{Θ} and does not take into account the occurrence of an event composed of \vec{W}, \vec{H}, \vec{x}, and \vec{y}. In certain examples, the prior probability can be characterized by a normal, or Gaussian, probability distribution given by:

$$P ( \overline{Θ} ) \approx N ( \overline{Θ} \vert {\overline{Θ}}_{1} , {Λ}_{1}^{- 1} ) N ( \overline{Θ} \vert {\overline{Θ}}_{2} , {Λ}_{2}^{- 1} ) x exp ( {( {\overline{Θ}}_{1} - \overline{Θ} )}^{T} \frac{{Λ}_{1}}{2} ( {\overline{Θ}}_{1} - \overline{Θ} ) ) exp ( {( {\overline{Θ}}_{2} - \overline{Θ} )}^{T} \frac{{Λ}_{2}}{2} ( {\overline{Θ}}_{2} - \overline{Θ} ) ) \qquad ( 17 )$$

where \vec{Θ}₁ is a vector composed of independent mean values for the parameters set by a document designer; A₁ is a diagonal matrix of variances for the independent parameters set by the document designer: A₂=C^{T}Δ^{T}ΔC is a on-diagonal covariance matrix for dependent parameters; and Θ̅₂=A⁻¹C^{T}Δ^{T}Δ d̅ is a vector composed of dependent mean values for the parameters. The matrix C and the vector d̅ characterize the linear relationships between the parameters of the parameter vector Θ̅ given by C Θ̅= d̅ and Δ is a covariance precision matrix.

Returning to equation (16), the term P( W̅, H̅, x̅, y̅| Θ̅) is the conditional probability of an event composed of W̅, H̅, x̅, and y̅, given the occurrence of the parameters of the parameter vector Θ̅. In certain examples, the term P( W̅, H̅, x̅, y̅| Θ̅) can be characterized as follows:

$$P ( \overline{W} , \overline{H} , \overline{x} , \overline{y} \vert \overline{Θ} ) x {\prod }_{i} {\prod }_{j} N ( {W}_{i} \vert {\overline{Θ}}^{T} {\overline{x}}_{i} , {α}_{i}^{- 1} ) N ( {H}_{j} \vert {\overline{Θ}}^{T} {\overline{y}}_{j} , {β}_{j}^{- 1} ) \qquad ( 18 )$$

where

$$N ( {W}_{i} \vert {\overline{Θ}}^{T} {\overline{x}}_{i} , {α}_{i}^{- 1} ) ∝ exp ( - \frac{{α}_{i}}{2} {( {\overline{Θ}}^{T} {\overline{x}}_{i} - {W}_{i} )}^{2} ) , and$$

$$N ( {H}_{j} \vert {\overline{Θ}}^{T} {\overline{y}}_{j} , {β}_{j}^{- 1} ) ∝ exp ( - \frac{{β}_{j}}{2} {( {\overline{Θ}}^{T} {\overline{y}}_{j} - {H}_{j} )}^{2} )$$

are normal probability distributions. The variables αᵢ⁻¹ and βⱼ⁻¹ are variances and Wᵢ and Hⱼ represent n values for the distributions N(Wᵢ| Θ̅^{T} x̅ᵢ,αᵢ⁻¹) and N(Hⱼ| Θ̅^{T} y̅ⱼ,βⱼ⁻¹), respectively. Normal distributions can be used to characterize, at least approximately, the probability distribution of a variable that tends to cluster around the mean. In other words, variables close to the mean are more likely to occur than are variables farther from the mean. The normal distributions N(Wᵢ| Θ̅^{T} x̅ᵢ,αᵢ⁻¹) and N(Hⱼ| Θ̅^{T} y̅ⱼ,βⱼ⁻¹) characterize the probability distributions of the variables Wᵢ and Hⱼ about the mean values Θ̅^{T} x̅ᵢ and Θ̅^{T} y̅ⱼ, respectively.

The posterior probability P( Θ̅| W̅, H̅, x̅, y̅) can be maximized when the exponents of the normal distributions of equation (8) satisfy the following conditions:

Θ̅^{T} x̅ᵢ−Wᵢ≈0 and Θ̅^{T} y̅ⱼ−Hⱼ≈0

for all i and j. As described above, for a template, Wᵢ and Hⱼ are constants and the elements of x̅ᵢ and y̅ⱼ are constants. These conditions are satisfied by determining a parameter vector Θ̅^{MAP} that maximizes the posterior probability P( Θ̅| W̅, H̅, x̅, y̅). The parameter vector Θ̅^{MAP} can be determined by rewriting the posterior probability P( Θ̅| W̅, H̅, x̅, y̅) as a multivariate normal distribution a well-characterized mean and variance as follows:

$$P ( \overline{Θ} \vert \overline{W} , \overline{H} , \overline{x} , \overline{y} ) = N ( \overline{Θ} \vert {\overline{Θ}}^{MAP} , {( Λ + {\sum }_{i} {α}_{i} {\overline{x}}_{i} {\overline{x}}_{i}^{T} + {\sum }_{j} {β}_{j} {\overline{y}}_{j} {\overline{y}}_{j}^{T} )}^{- 1} ) \qquad ( 19 )$$

The parameter vector Θ̅^{MAP} is the mean of the normal distribution characterization of the posterior probability P( Θ̅| W̅, H̅, x̅, y̅), and Θ̅ maximizes P( Θ̅| W̅, H̅, x̅, y̅) when Θ̅ equals Θ̅^{MAP}. Solving P( Θ̅| W̅, H̅, x̅ y̅) for Θ̅^{MAP} gives the following chased form expression:

$${\overline{Θ}}^{MAP} = {( Λ + {\sum }_{i} {α}_{i} {\overline{x}}_{i} {\overline{x}}_{i}^{T} + {\sum }_{j} {β}_{j} {\overline{y}}_{j} {\overline{y}}_{j}^{T} )}^{- 1} ( Λ \overline{Θ} + {\sum }_{i} {α}_{i} {W}_{i} {\overline{x}}_{i} + {\sum }_{j} {β}_{j} {H}_{j} {\overline{y}}_{j} ) \qquad ( 20 )$$

The parameter vector Θ̅^{MAP} can also be rewritten in matrix from as follows:

Θ̅^{MAP}=A⁻¹ b̅ (21)

where

$$A = Λ + {\sum }_{i} {α}_{i} {\overline{x}}_{i} {\overline{x}}_{i}^{T} + {\sum }_{j} {β}_{j} {\overline{y}}_{j} {\overline{y}}_{j}^{T}$$

is a matrix and A⁻¹ is the inverse of A, and

$$\overline{b} = ΛΘ + {\sum }_{i} {α}_{i} {W}_{i} {\overline{x}}_{i} + {\sum }_{j} {β}_{j} {H}_{j} {\overline{y}}_{j}$$

is a vector.

In summary, given a single page template and figures to be placed in the image fields of the template, the parameters used to scale the images and white spaces of the template can be determined from the closed form equation for Θ̅^{MAP}.

Once the parameters of the parameter vector Θ̅^{MAP}are determined ng the closed form equation for Θ̅^{MAP}, the template can be rendered by multiplying un-scaled dimensions of the images and widths of the white spaces by corresponding parameters of the parameter vector Θ̅^{MAP}.

The elements of the parameter vector Θ̅^{MAP}may also be subject to boundary conditions on the image fields and white space dimensions arising from the minimum width constraints for the margins. In other examples, in order to determine Θ̅^{MAP}subject to boundary conditions, the vectors x̅₁, x̅₂, y̅₁, and y̅₂, the variances α₁⁻¹, α₂⁻¹, β₁⁻¹, and β₂⁻¹, and the constants W₁, W₂, H₁, and H₂ are inserted into the linear equation A Θ̅^{MAP}= b̅, and the matrix equation solved numerically for the parameter vector Θ̅^{MAP} subject to the boundary conditions on the parameters of Θ̅^{MAP}. The matrix equation A Θ̅^{MAP}= b̅ can be solved using any well-known numerical method for solving matrix equations subject to boundary conditions on the vector Θ̅^{MAP}, such as the conjugate gradient method.

As explained above, in sonic examples, the probabilistic layout engine uses an API to a graphics design or rendering tool (e.g., the Scribus API) to create the final document 16. For each page, the rendering engine traverses the Y and X paths of the chosen page template and renders content blocks as they are encountered. Optimal template parameters determined via inference are used directly to determine the positions, widths, and heights of all blocks. The rendering engine produces a render table structure that keeps track of items that have already been rendered to avoid duplicate rendering. Text blocks are rendered in the Y-path and image blocks are rendered after a complete X and Y pass. Separate layers are created to render background and foreground items.

Examples of the document processing system 10 may be implemented by one or more discrete modules (or data processing components) that are not limited to any particular hardware, or machine readable instructions (e,g, firmware or software) configuration. In the illustrated examples, these modules may be implemented in any computing or data processing environment, including in digital electronic circuitry (e.g., an application-specific integrated circuit, such as a digital signal processor (DSP)) or in computer hardware, device driver, or machine readable instructions (including firmware or software). In some examples, the functionalities of the modules are combined into a single data processing component. In some examples, the respective functionalities of each of one or more of the modules are performed by a respective set of multiple data processing components.

The modules of the document processing system 10 may be co-located on a single apparatus or they may be distributed across multiple apparatus distributed across multiple apparatus, these modules may communicate with each other over local wired or wireless connections, or they may communicate over global network connections (e.g., communications over the Internet).

In some implementations, process instructions (e.g., machine-readable code, such as computer software) for implementing the methods that are executed by the examples of the document processing system 10, as well as the data they generate, are stored in one or more machine-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

In general, examples of the variable document template generation system 10 may be implemented in any one of a wide variety of electronic devices, including desktop computers, workstation computers, and server computers.

FIG. 8 shows an example of a computer system 140 that can implement any of the examples of the document processing system 10 that are described herein. The computer system 140 includes a processing unit 142 (CPU), a system memory 144, and a system bus 146 that couples processing unit 142 to the various components of the computer system 140. The processing unit 142 typically includes one or more processors, each of which may be in the form of any one of various commercially available processors. The system memory 144 typically includes a read only memory (ROM) that stores a basic input/output system (BIOS) that contains startup routines for the computer system 140 and a random access memory (RAM). The system bus 146 may be a memory bus, a peripheral bus or a local bus, and may be compatible with any of a variety of bus protocols, including PCI, VESA, Microchannel, ISA, and EISA. The computer system 140 also includes a persistent storage memory 148 (e.g., a hard drive, a floppy drive, a CD ROM drive, magnetic tape drives, flash memory devices, and digital video disks) that is connected to the system bus 146 and contains one or more computer-readable media disks that provide non-volatile or persistent storage for data data structures and computer-executable instructions.

A user may interact (e.g., enter commands or data) with the computer 140 using one or more input devices 150 (e.g., a keyboard, a computer mouse, a microphone, joystick, and touch pad). Information may be presented through a user interface that is displayed to a user on the display 151 (implemented by, e.g., a display monitor), which is controlled by a display controller 154 (implemented by, e.g., a video graphics card). The computer system 140 also typically includes peripheral output devices, such as speakers and a printer. One or more remote computers may be connected to the computer system 140 through a network interface card (NIC) 156.

As shown in FIG. 8, the system memory 144 also stores the document processing system 10, a graphics driver 158, and processing information 160 that includes input data, processing data, and output data In some examples, the document processing system 10 interfaces with the graphics driver 158 to present a user interface on the display 151 for managing and controlling the operation of the document processing system 10.

Other embodiments are within the scope of the claims.

1. A method, comprising:
receiving document content (16) for rendering in accordance with one or more variable document templates (18), wherein each variable document template comprises one or more respective template elements associated with respective parameters defining relative sizes and positions of the template elements on a page;
assigning scores to respective allocations of the document content (16) to a page;
based on the scores, determining an optimal umber of pages to layout the document content (16);
ascertaining from the optimal number of pages a respective optimal allocation of the document content (16) to each of the optimal number of pages, a respective optimal one of the variable document templates for each of the optimal number of pages, and optimal values of the parameters of the template elements of the ascertained optimal variable document template for each of the optimal number of pages; and
generating a document (12) based on the optimal allocations, the optimal variable document templates, and the optimal values of the parameters that respectively are ascertained for the optimal number of pages;
wherein the receiving, the assigning, and the determining are performed by a computer system (140).

2. The method of claim 1, wherein the assigning comprises, for each of the respective allocations, assigning a respective maximal score for a layout of the respective allocation on a page in accordance with each of the one or more variable document templates (18).

3. The method of claim 1, wherein the determining comprises
for each of multiple cumulative subsets of the document content (16):
determining a highest scoring combination of a current allocation of document content within the cumulative subset to a current page and a prior allocation of document content within the cumulative subset to each page preceding the current page; and
setting a current page count equal to a page count associated with the current page; and
wherein the optimal number of pages corresponds to the current page count set for the cumulative subset equal to all the document content (16).

4. The method of claim 3, wherein the setting comprises increment the current page count equal to one more than a count of the pages preceding the current page.

5. The method of claim 3, wherein the ascertaining comprises:
allocating all the document content (16) to a last one of the pages highest in page number; and
for each pair of consecutive pages from a last one of the pages to a first one of the pages, assigning to the page of the pair higher in page number a respective portion of the document content (16) corresponding to a difference between the document content respectively allocated to the page of the pair higher in page number and the document content respectively allocated to the page of the pair consecutively lower in page number.

6. The method of claim 5, wherein the determining comprises, for each of multiple cumulative subsets of the document content (16), storing the prior allocation of the document content in a data structure in association with an index value corresponding to the page preceding the current page; and the assigning comprises sequentially retrieving the prior allocations stored in the data structure in order from the highest index value to the lowest index value, and determining respective differences between consecutive ones of the retrieved prior allocations.

7. The method of claim wherein the ascertaining comprises:
for each of the optimal number of pages, determining a respective one of the one or more variable document templates (18) for rendering the respective optimal allocation of the document content (16) ascertained for the page in accordance with a probabilistic optimization process.

8. The method of claim 7, wherein the ascertaining comprises:
for each of the optimal number of pages, determining optimal values of the parameters of the respective variable document template respectively determined for the page.

9. The method of claim 1, wherein each variable document template comprises at least one template element that is associated with a respective parameter characterized by one or more values that define a respective degree of variability of the associated parameter.

10. Apparatus, comprising:
a computer-readable memory (144, 148) storing computer-readable instructions; and
a data processor (142) coupled to the memory, operable to execute the instructions, and based at least in part on the execution of the instructions operable to perform operations comprising
receiving document content (16) for rendering in accordance with one or more variable document templates (18), wherein each variable document template comprises one or more respective template elements associated with respective parameters defining relative sizes and positions of the template elements on a page;
assigning scores to respective allocations of the document content (16) to a page, a respective optimal one of the variable document templates for each of the optimal number of pages, and optimal values of the parameters of the template elements of the ascertained optimal variable document template for each of the optimal number of pages;
based on the scores, determining an optimal number of pages to layout the document content (16);
ascertaining from the optimal number of pages a respective optimal allocation of the document content (16) to each of the optimal number of pages; and
generating a document (12) based on the optimal allocations, the optimal variable document templates, and the optimal values of the parameters that respectively are ascertained for the optimal number of pages.

11. The apparatus of claim 10, wherein the assigning comprises, for each of the respective allocations, assigning a respective maximal score for a layout of the respective allocation on a page in accordance with each of the one or more variable document templates (18).

12. The apparatus of claim 10, wherein in the determining the data processor is operable to perform operations comprising
for each of multiple cumulative subsets of the document content (16):
determining a highest scoring combination of a current allocation of document content within the cumulative subset to a current page and a prior allocation of document content within the cumulative subset to each page preceding the current page; and
setting a current page count equal to a page count associated with the current page; and
wherein the optimal number of pages corresponds to the current page count set for the cumulative subset equal to all the document content (16).

13. The apparatus of claim 12, wherein in the ascertaining the data process or operable to perform operations comprising:
allocating all the document content (16) to a last one of the pages highest in page number; and
for each pair of consecutive pages from a last one of the pages to a first one of the pages, assigning to the page of the pair higher in page number a respective portion of the document content (16) corresponding to a difference between the document content respectively allocated to the page of the pair higher in page number and the document content respectively allocated to the page of the pair consecutively lower in page number.

14. The apparatus of claim 13, wherein in the determining the data processor is operable to perform operations comprising, for each of multiple cumulative subsets of the document content (16), storing the prior allocation of the document content in a data structure in association with an index value corresponding to the page preceding the current page; and the assigning comprises sequentially retrieving the prior allocations stored in the data structure in order from the highest index value to the lowest index value, and determining respective differences between consecutive ones of the retrieved prior allocations.

15. At least one non-transitory computer-readable medium (144, 148) having computer-readable program code embodied therein, the computer-readable program code adapted to be executed by a computer (140) to implement a method comprising:
receiving document content (16) for rendering in accordance with one or more variable document templates (18), wherein each variable document template comprises one or more respective template elements associated with respective parameters defining relative sizes and positions of the template elements on a page;
assigning scores to respective allocations of the document content (16) to a page;
based on the scores, determining an optimal number of pages to layout the document content (16);
ascertaining from the optimal number of pages a respective optimal allocation of the document content (16) to each of the optimal number of pages, a respective optimal one of the variable document templates for each of the optimal number of pages, and optimal values of the parameters of the template elements of the ascertained optimal variable document template for each of the optimal number of pages; and
generating a document (12) based on the optimal allocations, the optimal variable document templates, and the optimal values of the parameters that respectively are ascertained for the optimal number of pages.
